(19) United States
(12) Patent Application Publication
(10) Pub. No.: US 2013/0031900 A1
(43) Pub. Date: Feb. 7, 2013

(54) High Efficiency Heat Exchanger and Thermal Engine Pump

(71) Applicants: Peter Andrew Nelson, Scottsdale, AZ (US); Vinod Kumar Selvaraju, Tempe, AZ (US); Vishwanathan Pulugandi, Tempe, AZ (US); Alok Ashok Patil, Hauppauge, NY (US)

(72) Inventors: Peter Andrew Nelson, Scottsdale, AZ (US); Vinod Kumar Selvaraju, Tempe, AZ (US); Vishwanathan Pulugandi, Tempe, AZ (US); Alok Ashok Patil, Hauppauge, NY (US)

(21) Appl. No.: 13/198,778

(22) Filed: Aug. 5, 2011

(51) Int. Cl. F03C 1/00; F28D 3/02

(52) U.S. Cl. 60/530; 165/157

(57) ABSTRACT

A high efficiency shell and tube heat exchanger coupled to a hydraulic thermal engine includes an insulated cylindrical shell having first and second ends for conveying a coolant and a plurality of tubes passing through at least one of the ends for conveying a working fluid. A plurality of spaced-apart generally-transverse baffles are disposed in the shell. Each baffle is truncated along one edge defining a slot for passage of coolant along the shell inner wall and past the baffle. Successive of the baffles are rotated with respect to the longitudinal axis of the shell to cause the coolant flowing therethrough to follow a non-axial path. Multiple coolant inlets and outlets may be provided. The heat exchanger is optimized for a use wherein the second working fluid is liquid CO₂ in a supercritical fluid state. The heat exchanger tubes have an inside diameter of 0.26 inches or less.

### TECHNICAL FIELD

The present invention relates to heat exchangers; more particularly, to a shell and tube heat exchanger coupled to a hydraulic thermal engine; and most particularly, to a shell and tube heat exchanger having an improved heat-exchanging rate such that the hydraulic thermal engine may be powered using readily available low level heat energy (180° F.), such as for example, solar energy.

### BACKGROUND OF THE INVENTION

U.S. Pat. No. 5,899,067, the relevant disclosure of which is incorporated herein by reference, discloses a hydraulic thermal engine (herein also referred to as an “HT engine”) powered by introduction and removal of heat from a working fluid that changes volume with changes in temperature. A container houses the working fluid, and a cylinder secured to the frame includes an interior space. The cylinder also includes a passage for introducing the working fluid into the interior space. A piston is housed within the interior space of the cylinder. The working fluid container, the interior space of the cylinder, and the piston define a closed space filled by the working fluid. The HT engine also includes means for transmitting heat to and removing heat from the working fluid, thereby alternately causing the working fluid to expand and contract without undergoing a phase change. The piston moves in response to the expansion and contraction of the working fluid.

Shell and tube heat exchangers (also referred to hereinbelow generically as “heat exchangers”) are known in the prior art as well. Such a device typically comprises a cylindrical container (shell), for conveying a cooling or heating fluid (referred to herein as “coolant”) through the shell, and a plurality of tubes passing longitudinally through the shell and immersed in the coolant for conveying a working fluid to be heated or chilled by energy exchange with the coolant through the walls of the tubes.

Efficiency of a heat exchanger is limited by, among other parameters, the rate at which heat can be transferred through the walls of the tubes.

It is known in the art to increase heat transfer efficiency by increasing the total transfer surface area by increasing the number of tubes per unit cross-sectional area; by forming the tubes of material having higher heat transfer coefficient; and by making the walls of the tubes thinner.

It is also known to baffle the flow of coolant through the shell to try to minimize the thickness and residence time of a boundary layer on the outer walls of the tubes and the inner surface of the shell.

It is also known to minimize the thickness of the tube walls to minimize the tidal heat energy in the system and speed of response during alternating heating and cooling cycles.

It is also known that the rate of heat transfer is a function of the absolute temperature difference between the coolant and the working fluid.

It will be appreciated that the capability of the disclosed engine for doing work is dependent directly upon the efficiency of the associated heat exchanger.

What is needed in the art is an improved high efficiency shell and tube thermal heat exchanger.

It is a principal object of the present invention to increase the work output of an HT engine.

It is a further object of the present invention to increase the output of mechanical devices driven by an HT engine.

It is a still further object of the present invention to improve the efficiency and output of an HT engine through the use of a low level, readily available heat source to power the HT engine.

### SUMMARY OF THE INVENTION

Briefly described, an improved high efficiency shell and tube heat exchanger in accordance with the present invention comprises an insulated cylindrical shell having first and second ends for conveying a coolant and a plurality of tubes passing through at least one of the ends for conveying a working fluid. A plurality of spaced-apart generally-transverse baffles are disposed in the shell, wherein one or more (preferably all) of the tubes passes through the plurality of baffles. Each baffle is truncated along one edge defining a slot for passage of coolant along the shell inner wall and past the baffle. Successive baffles may be rotated with respect to the longitudinal axis of the shell to cause the coolant flowing therethrough to follow a non-axial path, preferably sinusoidal or helical. Multiple coolant inlets and outlets may be provided. In one aspect of the invention, the shell is divided by at least one transverse dam into a plurality of shell spaces, each of which is provided with an inlet and an outlet for the coolant (the tubes being continuous through the transverse dam).

It will be appreciated that the heat transfer efficiency per unit length of the heat exchanger is dependent of the overall length. Thus, the length of the heat exchanger may be selected according to the volume of working fluid a particular application requires.

In an exemplary embodiment, the heat exchanger is optimized for a use wherein the second working fluid is liquid CO₂ in a supercritical fluid state, and the coolant is water. The heat exchanger is dimensionally optimized to maximize heat exchange rate; provide for capability to handle alternate flow of hot and cold water in a quick cycle; minimize water flow rates; withstand design pressures up to 3600 psi; provide sufficient CO₂ volume to drive associated piston movement; and keep the CO₂ volume low enough to maintain a high pressure differential across the tube walls.

### BRIEF DESCRIPTION OF THE DRAWINGS

The present invention will now be described, by way of example, with reference to the accompanying drawings, in which:

FIG. 1 is a schematic drawing showing an HT engine operationally connected to exemplary first and second heat exchangers formed in accordance with the present invention;

FIG. 2 is an isometric view of the exterior of an exemplary heat exchanger in accordance with the present invention;

FIG. 3 is an isometric view similar to the view shown in FIG. 2 but with the heat exchanger shell removed;

FIG. 4 is a plan view of an intermediate transverse dam within the heat exchanger shown in FIGS. 2 and 3;

FIG. 5 is a plan view of an end plate within the heat exchanger;

FIG. 6 is a plan view of a baffle within the heat exchanger; and

FIG. 7 is temperature/pressure phase diagram for carbon dioxide.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

An HT engine, in its simplest form, comprises a piston slidably disposed in a cylinder. For performing work the piston may be exposed on a first side to a crankshaft through a connecting rod or, as exemplified herein, a first working fluid in communication with a hydraulically driven apparatus, e.g., an air conditioner or a desalination unit. The slidable piston is exposed on its opposite side to and in direct fluid communication with a second working fluid contained in a closed chamber and having a high coefficient of thermal expansion. The closed chamber comprises that portion of the cylinder occupied by the second working fluid and by a heat exchanger. The heat exchanger is a shell and tube type and may be integrated with that portion of the cylinder or, as exemplified herein, disposed distinct from the cylinder portion but in hydraulic communication therewith.

In operation, hot and cold coolants are alternately pumped through the shell of the heat exchanger, enveloping the tubes in the heat exchanger occupied by the second working fluid. When the coolant is higher in temperature than the second working fluid, heat is absorbed by the second working fluid and the second working fluid is caused to expand, thereby increasing the overall volume of the second working fluid not only in the tubes but in the cylinder adjacent the piston as well, creating a force on the piston to move the piston in a first direction away from the expanding fluid. When subsequently a coolant lower in temperature is pumped through the heat exchanger shell, heat is absorbed by the coolant and the second working fluid in the tubes and in the cylinder is caused to contract, thereby decreasing the overall volume of the second working fluid. The volume of the second working fluid creates a force imbalance on the piston causing the piston to move in a second and opposite direction of the first direction toward the contracting fluid. With appropriate valving of the first working fluid, and the sequential applications of cool and hot coolant, the engine can be useful as a positive displacement pump.

It will be seen that, on the side opposite the working fluid, the piston may be connected to a crank via an articulated connecting rod, as disclosed in the incorporated reference patent or, as in the example disclosed, by a fixed connecting rod through an intermediate cylinder space to a second oppositely-acting HT engine disposed collinearly and face-to-face with the first HT engine and operated by a second heat exchanger. The first working fluid is disposed between opposing HT engines and may be connected by appropriate valving to a hydraulically powered apparatus in known fashion. The two HT engines may be made to work in tandem by programming the heating and cooling cycles of their respective second working fluids in the respective first and second heat exchangers to be out of phase with each other.

It will be seen that this arrangement is incapable of doing net work, as the volume of the first HT engine cylinder that is swept by the first piston is exactly equal and opposite to the volume of the second HT engine cylinder that is swept in the opposing portion of the operating cycle by the second piston. Therefore, a third piston is disposed on the rigid connecting rod in the intermediate cylinder space midway between the first and second HT engine pistons. The third piston, which may be thought of as a compression piston, serves to divide the intermediate cylinder (with appropriate valving) into two distinct compression chambers capable of pumping the first working fluid between the compression chambers via an attached hydraulic apparatus. Note that, to optimize the force relationships in the system, the intermediate cylinder need not be of the same diameter as the two HT engine cylinders.

Regarding the heat exchangers, it has been found that a shell and tube heat exchanger produces surprising engine efficiencies and is well adapted to the present use. In conventional double-ended flow-through shell and tube heat exchangers, although it is desirable to increase the total heat exchange area by decreasing the diameter of the tubes, there is a lower limit to tube diameter because of the reduction of volume of the working fluid and its viscous drag, which increases exponentially with decrease in tube diameter. For practical reasons, then, the prior art teaches to limit tube inside diameters (ID) to values well above 0.25 inches and teaches away from smaller diameter tubes of 0.25 inches or less.

However, in the present invention, the heat exchanger is a special case because there is no net flow through the tubes, only a tidal volume of a working fluid that expands and contracts. Further, viscous losses decrease with distance from the open end into the tubes because there is progressively less fluid passing through each tube during expansion and contraction; indeed, at the closed ends of the tubes, there is zero fluid flow at any time. Recognizing this, the inventors have found surprisingly that ID values smaller than 0.25 inch are not only practical but are operationally desirable for maximizing the effectiveness of the HT engine and of the heat exchanger for the particular working fluid selected, which is supercritical carbon dioxide.

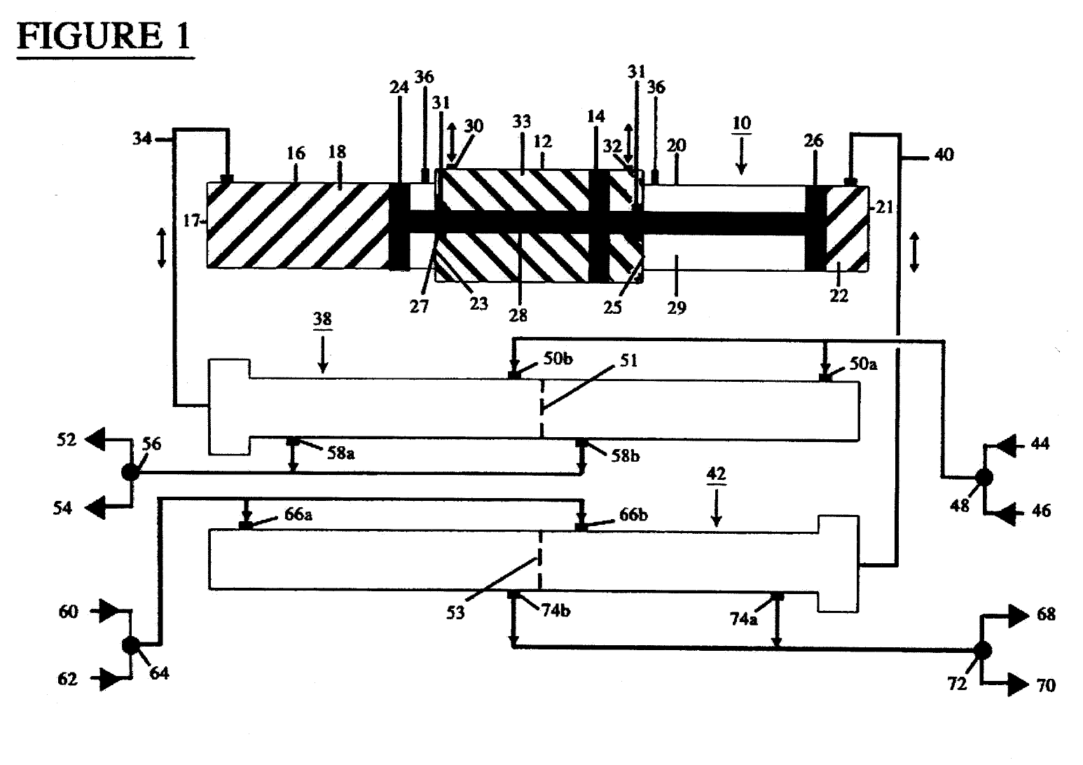

Referring to FIG. 1, a schematic of a three-piston HT engine system 10 is shown. Engine system 10 comprises a central cylinder 12 containing a central compression piston 14. A first HT engine cylinder 16 having a first end wall 17 and a second HT engine cylinder 20 having a second end wall 21 interface with central cylinder 12 at intermediate walls 23, and 25, respectively. First and second HT engine cylinders 16,20 are co-linear with central cylinder 12. HT engine cylinders 16 and 20 contain respective first and second HT pistons 24,26. The three pistons 14,24,26 may be rigidly connected by a linear connecting rod 28, as shown. Connecting rod 28 passes through intermediate walls 23 and 25 through openings 27,29. Rod seals 31 are disposed around openings 27,29 between rod 28 and the openings. The volume of cylinder 12 between piston 14 and intermediate wall 23 on one side and between piston 14 and intermediate wall 25 on the other side is occupied by a first working fluid 33.

First HT engine cylinder 16 between piston 24 and first end wall 17 contains an amount of a second working fluid 18; and second HT engine cylinder 20 between piston 26 and second end wall 21 contains an amount of the second working fluid 22.

First working fluid 33 may be in fluid communication with a hydraulically driven apparatus such as, for example, an AC compressor or a desalinization pump (not shown), as disclosed hereinabove, via first and second outlet ports and valves 30,32.

First HT engine cylinder 16 is in fluid communication via line 34 with a first shell and tube heat exchanger 38 also containing an amount of second working fluid 18 in accordance with the present invention. Second HT engine cylinder 20 is in fluid communication via line 40 with a second shell and tube heat exchanger 42 also containing an amount of second working fluid 18 in accordance with the present invention.

A first hot water supply 44 and a first cold water supply 46 are connected via a three-way valve 48 to an inlet 50a, in the shell of first exchanger 38. A first hot water return 52 and a first cold water return 54 are connected via a three-way valve 56 to an outlet 58a in the shell of first exchanger 38.

A second hot water supply 60 and a second cold water supply 62 are connected via a three-way valve 64 to an inlet 66a in the shell of second exchanger 42. A second hot water return 68 and a second cold water return 70 are connected via a three-way valve 72 to an outlet 74a in the shell of second exchanger 34.

In one aspect of the invention, multiple inlets and outlets may be used along the length of the heat exchangers to optimize the heat transferred to and away from second working fluids 18,22. For example, in first heat exchanger 38, first hot water supply 44 and a first cold water supply 46 may be connected via three-way valve 48 to a plurality of inlets 50a,50b, exemplarily shown as two, on opposite sides of a transverse dam 51 in the first exchanger's shell. Further, first hot water return 52 and first cold water return 54 may be connected via three-way valve 56 to a plurality of outlets 58a,58b, exemplarily shown as two, on opposite sides of dam 51 in the first exchanger's shell.

Similarly, in second heat exchanger 42, second hot water supply 60 and second cold water supply 62 may be connected via three-way valve 64 to a plurality of inlets 66a,66b, exemplarily shown as two, on opposite sides of a transverse dam 53 in the second exchanger's shell. Further, second hot water return 68 and second cold water return 70 may be connected via three-way valve 72 to a plurality of outlets 74a,74b, exemplarily shown as two, on opposite sides of dam 53 in the second exchanger's shell.

As can be seen in FIG. 1, because of the placement of central dam 51,53 between sets of inlets/outlets, a first flow circuit isolated from a second flow circuit is formed.

The following operating description is provided for first heat exchanger 38, although it should be recognized that the operation (not described) of second heat exchanger 42 is identical but 180° out of phase with that of first heat exchanger 38.

In operation, when three-way valves 48,56 are in a first position, hot water from supply 44 enters first heat exchanger 38 via inlet 50a (or 50a,50b), passes through the shell as described below, and exits heat exchanger 38 via outlets 58a (or 58a,58b) and hot water return 52, causing working fluid in the tubes within heat exchanger 38 to expand. The hot water from hot water supply 44 may be heated, for example, by solar energy or by surrounding waste heat. Expanded working fluid flows from heat exchanger 38 through line 34 into cylinder 16, urging piston 24 to the right in FIG. 1. Air in the chamber between piston 24 and intermediate wall 23, that would otherwise be trapped, may be exhausted through port 36. When three-way valves 48,56 are in a second position, cold water from supply 46 enters first heat exchanger 38 via inlet 50a (or 50a,50b), passes through the shell and exits heat exchanger 38 via outlet 58a (or 58a,58b) and cold water return 54, causing working fluid in the heat exchanger to contract. When piston 24 is drawn toward the contracting working fluid in cylinder 16, air may be drawn back into the chamber between piston 24 and intermediate wall 23 through port 36. Contracted working fluid flows through line 34 from cylinder 16 into heat exchanger 38, urging piston 24 to the left in FIG. 1.

A great advantage of the present invention is that hot water sources 44 of the exemplary heat exchanger may be derived from a solar hot water heater (not shown) as is known in the art, thus making the present invention highly useful for driving processes such as desalination without requiring fossil fuels and internal combustion engines. Moreover, depending on the rate of thermal expansion of the second working fluid, the volume of the second working fluid and the diameter of piston 24 the temperature difference between the hot water supply 44 and the cold water supply 46 may be surprisingly small, allowing the use of cheap and readily available waste heat, as for example, a working fluid primarily heated by solar energy, to drive the engine.

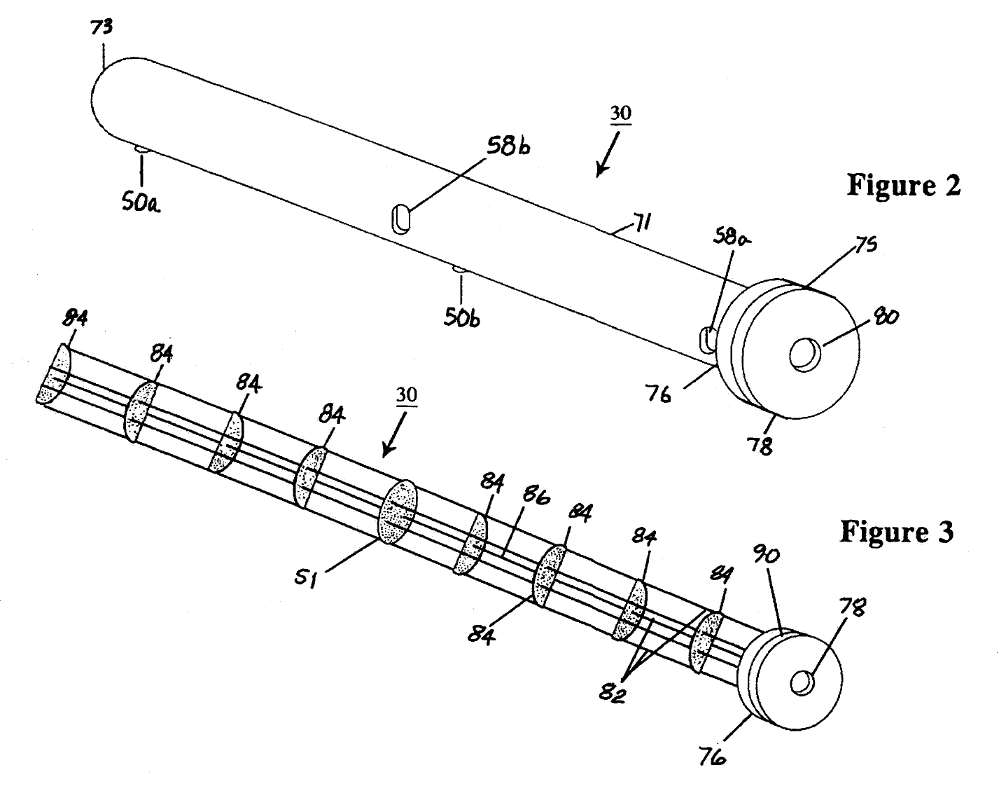

Referring now to FIGS. 2 through 6, heat exchanger 38 comprises an insulated shell 71 closed at a first end 73 and having first and second coolant inlets 50a,50b and first and second coolant outlets 58a,58b as described above. At the open end 75, a shell flange 76 is mounted to shell 71. A cap 78 is connected to shell flange 76 to seal the end of shell 71 and withstand high pressures within the heat exchanger. Cap 78 includes a central opening 80 for receiving a connecting fitting (not shown) for attaching line 34.

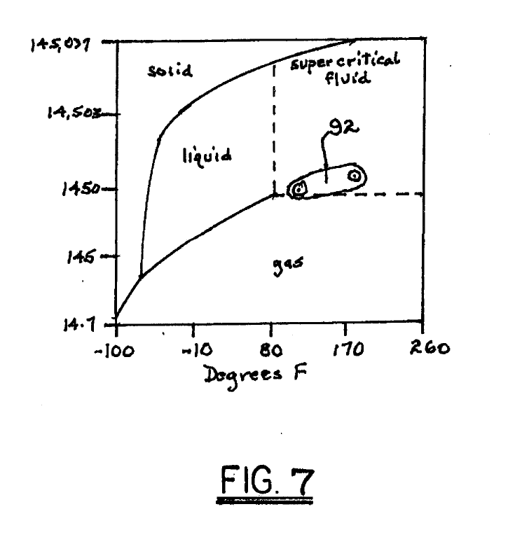

Within shell 71 is a structure comprising a plurality of longitudinal stringer rods 82 passing through and connecting a plurality of perforated baffles 84 having truncated edges 85 (see FIG. 6) and central dam 51. A plurality of longitudinal heat exchange tubes 86 (only one shown in FIG. 3), each tube 86 being closed at shell end 73, also passes through baffles 84 and dam 51. Tubes 86 are open at their opposite ends and terminate in a distribution chamber (not shown) within header flange 78. Working fluid entering and leaving through opening 80 is distributed to, and collected from, tubes 86.

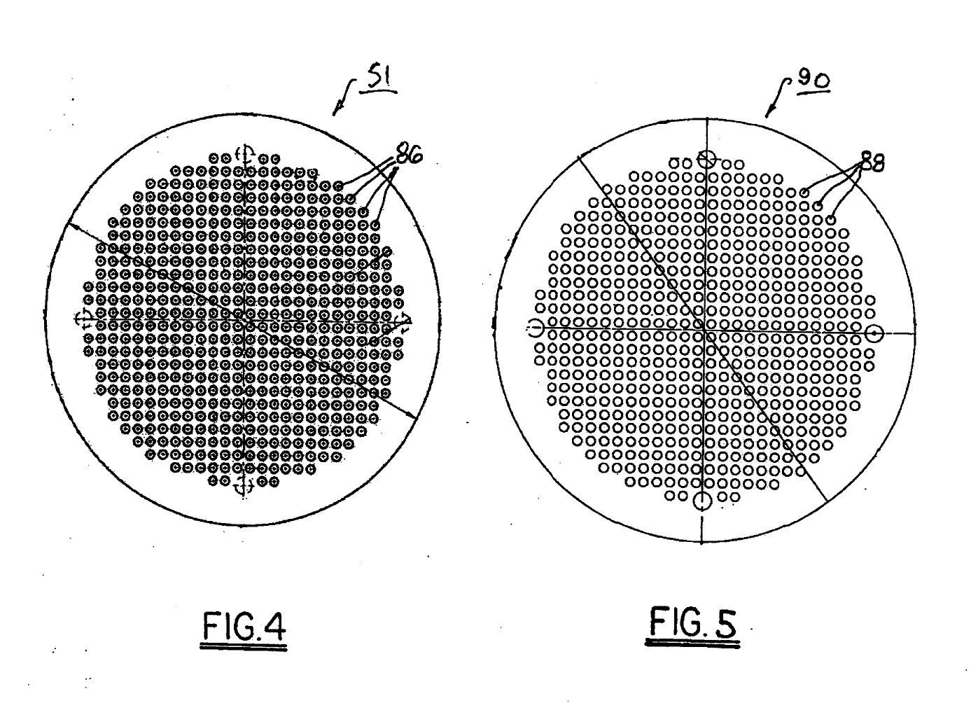

Referring to FIGS. 4 and 6, tubes 86 pass through baffles 84 (and optionally through central dam 51) in a preferably rectangular pattern. Central dam 51 may be sealed around its periphery to the interior wall of shell 71. Further, tubes 86 are sealed to dam 51 to prevent the passage of water across dam 51.

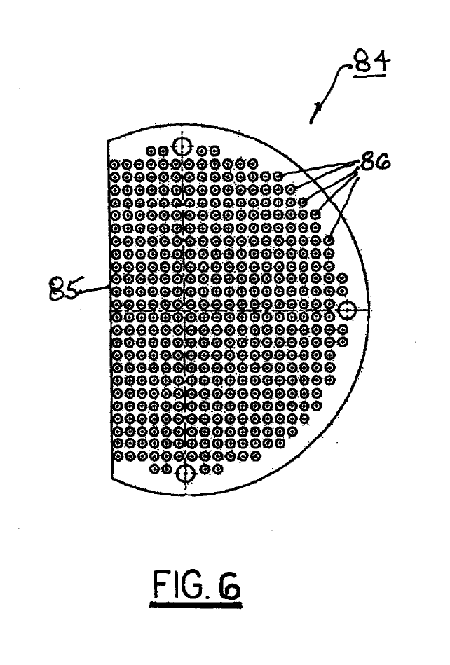

Referring to FIG. 5, open ends of tubes 86 are in fluid communication with the distribution chamber and terminate in openings 88 in a spacer 90 also sealed around its periphery to the interior wall of shell 71.

Referring to FIG. 7, a currently-preferred first working fluid 18,22 is superfluid carbon dioxide (CO₂) maintained within an operating temperature and pressure range 92. In currently-preferred operating conditions, the carbon dioxide is maintained at pressures between about 1150 psi and about 2400 psi, and at temperatures between about 120° F. and about 140° F., using alternating coolant cooling and heating temperatures of about 80° F. and about 180° F.

In an exemplary embodiment of the apparatus shown in FIG. 1, central cylinder 12 and piston 14 are 12.0 inches in diameter. First and second HT cylinders 16,20 and HT pistons 24,26 are 6.0 inches in diameter. The stroke of pistons 14,24,26 is 2.5 feet. Each heat exchanger 38,42 is 9.5 feet in overall length, has a shell inner diameter of 9.0 inches, and contains 568 tubes arranged at a pitch of 2.0, the pitch being the ratio of the tube OD to the distance between centers of adjacent tubes. The ID of each tube is between about 0.05 inches and about less than 0.26 inches, preferably about 0.118 inches. Baffles 84 are spaced at about 1 foot intervals along the inner wall of shell 71. Preferably, adjacent baffles are rotated through a central angle between 0° and 90° to create a nonlinear flow path for coolant flowing through shell 71 between the inlets and outlets. “Hot” water temperatures for the second working fluid may be about 182° F. at the shell inlets and about 162° F. at the shell outlets. Average CO₂ temperature within the heat exchanger is about 120° F. at maximum contraction and about 140° F. at maximum expansion. This embodiment is operated optimally at a stroke time of 9.60 seconds and a water flow rate of 74.8 gpm, sufficient to pump 12.27 cfm of first working fluid 27 through outlets/inlets 30,32.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A shell and tube heat exchanger, configured for providing heat energy to a hydraulic thermal engine, said heat exchanger comprising:
a) a tubular shell having a longitudinal axis and first and second ends and having at least one inlet and at least one outlet extending through said tubular shell to the interior thereof for entering and exiting of a coolant fluid; and
b) a plurality of tubes disposed longitudinally within said shell,
wherein said tubes are open at said first end of said shell and are closed at said second end of said shell; and
wherein an ID of at least some of said tubes is below about 0.26 inches.

2. The shell and tube heat exchanger in accordance with claim 1 wherein said ID is between about 0.05 inches and about 0.26 inches.

3. The shell and tube heat exchanger in accordance with claim 2 wherein said ID is about 0.118 inches.

4. The shell and tube heat exchanger in accordance with claim 1 further including a plurality of spaced-apart perforated baffles disposed along said longitudinal axis within said tubular shell, each spaced apart baffle having a truncated edge, wherein the truncated edge of at least one of said perforated baffles is angularly displaced with respect to the truncated edge of an adjacent one of said perforated baffles about a central angle between about 0° and about 90° and wherein at least some of said tubes pass through said perforations in said perforated baffles.

5. The shell and tube heat exchanger of claim 1 wherein said at least one inlet includes a plurality of inlets disposed along the longitudinal axis of the shell.

6. The shell and tube heat exchanger of claim 1 wherein said at least one outlet includes a plurality of outlets disposed along the longitudinal axis of the shell.

7. The shell and tube heat exchanger of claim 1 further including a transverse dam, wherein said at least one inlet includes a first inlet and a second inlet disposed along the longitudinal axis of the shell and said at least one outlet includes a first outlet and a second outlet disposed along the longitudinal axis of the shell, wherein said first inlet is in flow communication with said first outlet to form a first flow circuit, wherein said second inlet is in flow communication with said second outlet to form a second flow circuit and wherein said transverse dam is disposed between said first flow circuit and said second flow circuit to isolate a flow of said first flow circuit from a flow of said second flow circuit.

8. A shell and tube heat exchanger in accordance with claim 1 further comprising a cap attached to said shell and having an opening in communication with said open ends of said tubes.

9. A shell and tube heat exchanger in accordance with claim 1 wherein said plurality of tubes contain a working fluid and said working fluid is superfluid carbon dioxide.

10. A hydraulic thermal engine system, comprising:
a) a three-piston hydraulic thermal engine having a central cylinder containing a compression piston and a first cylinder and a second cylinder co-linear with said central cylinder, said first and second cylinders containing respective first and second pistons, wherein said central compression piston and said first and second pistons are coupled together, said central cylinder is occupied by a first working fluid, and wherein said first cylinder contains an amount of a second working fluid on an opposite side of said first piston from said first working fluid, and wherein said second cylinder contains an amount of said second working fluid on an opposite side of said second piston from said first working fluid;
b) a first heat exchanger in hydraulic communication with said first cylinder; and
c) a second heat exchanger in hydraulic communication with said second cylinder, wherein at least one of said first and second heat exchangers includes, a tubular shell having a longitudinal axis and first and second ends and having at least one inlet and at least one outlet extending through said tubular shell to the interior thereof for entering and exiting of a coolant fluid; and
a plurality of tubes disposed longitudinally within said shell, said plurality of tubes containing said second working fluid;
wherein an ID of at least some of said tubes is below about 0.26 inches.

11. a hydraulic thermal engine in accordance with claim 10 wherein said second working fluid is superfluid carbon dioxide.
